(19) United States
(12) Patent Application Publication
(10) Pub. No.: US 2025/0335186 A1
(43) Pub. Date: Oct. 30, 2025

(54) CONFIGURATION VALIDATION FOR CONTAINER DEPLOYMENTS IN A COMPUTING ENVIRONMENT

(71) Applicant: RED HAT, INC., Raleigh, NC (US)

(72) Inventors: Brian Gallagher, Waterford (IE); Carl Kyrillos, Raleigh, NC (US)

(21) Appl. No.: 18/648,892

(22) Filed: Apr. 29, 2024

(51) Int. Cl. G06F 8/71; G06F 8/60

(52) U.S. Cl. CPC G06F 8/71; G06F 8/60

(57) ABSTRACT

Some examples of the present disclosure relate to configuration validation for container deployments in a computing environment. In one particular example, a system can receive a request for a deployment of a container. A specification that is associated with the deployment can include a set of resources for running the container and an indicator for a repository storing source code associated with the container. Prior to running the container, the system can access the repository to determine a set of configuration requirements for running the container. The system can then determine a match or a mismatch between the set of resources and the set of configuration requirements. Based on the match or the mismatch, the system can perform an action.

### TECHNICAL FIELD

The present disclosure relates generally to deploying software in a computing environment. More specifically, but not by way of limitation, this disclosure relates to configuration validation for container deployments in a computing environment.

### BACKGROUND

Software can be deployed in computing environments using image files. An image file is generally a static file that includes executable code usable to deploy the software in a computing environment. An image file may also include the software's dependencies. Examples of such dependences can include the operating system, configuration files, packages, and libraries used to run the software. Incorporating the software's dependencies into the image files may allow the software to be quickly and easily deployed.

Image files are often configured for deploying their corresponding software inside isolated virtual environments that exist within a larger computing environment. For example, an image file may be configured to deploy software inside a container of a computing environment. A container is a relatively isolated virtual environment that can be generated by leveraging resource isolation features (e.g., cgroups and namespaces) of the Linux kernel. A deployment tool such as Docker® can be used to deploy the software inside the container from the image file. Deployment of software inside of such containers can be referred to as containerization.

### BRIEF DESCRIPTION OF THE DRAWINGS

FIG. 1 is a block diagram of an example of a system for configuration validation for container deployments in a computing environment according to some aspects of the present disclosure.

FIG. 2 is a block diagram of another example of a system for configuration validation for container deployments in a computing environment according to some aspects of the present disclosure.

FIG. 3 is a flow chart of an example of a process for configuration validation for container deployments in a computing environment according to some aspects of the present disclosure.

### DETAILED DESCRIPTION

A distributed computing environment can include a cluster of computing nodes to run software applications in a container. Some container orchestration platforms, such as Kubernetes, can be deployed in the distributed computing environment to enable the container to be executed using the cluster of computing nodes. But, configuration issues for containers may only become apparent at runtime in these container orchestration platforms. Configuration issues can include situations where environment variables or files are missing for a running container. The problems can arise from the container orchestration platform lacking awareness of the source code for the containerized application and its specific configuration requirements, making the container orchestration platform unable to proactively detect that certain configurations may be necessary for a container to function correctly at runtime. As a result, the container may encounter runtime errors caused by missing configurations that cannot be detected by container orchestration platforms, causing the container to perform sub-optimally. If a configuration issue is not detected until runtime, the configuration issue may be resource-intensive to correct. In addition, the containerized application may perform sub-optimally.

Some examples of the present disclosure can overcome one or more of the abovementioned problems by providing access and insights of source code for a container to validate a configuration of the container prior to running the container. A system can receive a request for a deployment of a container. A specification that is associated with the deployment can include a set of resources for running the container and an indicator for a repository storing source code associated with the container. Prior to running the container, the system can access the repository to determine a set of configuration requirements for running the container. The system can then determine a match or a mismatch between the set of resources and the set of configuration requirements, where a mismatch indicates that one or more of the configuration requirements are missing from the set of resources. Based on the match or the mismatch, the system can perform an action. For instance, if there is a match, the system may cause an execution of the container. Otherwise, the system may generate a notification about the mismatch or prevent the container from running until the set of resources matches the set of configuration requirements. As such, by using the source code, the system can preemptively validate the configuration of the container prior to running the container. Thus, runtime errors may be reduced and the container can have an improved performance.

As a particular example, a system may receive a request for a deployment of a container. A specification for the container can indicate that native resources of an environment variable named “ENV1” and a file named “FileA” are defined for running the container. The specification also indicates a Git repository that stores source code for the container. The system accesses the Git repository and performs static analysis on the source code to determine configuration requirements for running the container. For example, the system can determine that environment variables named “ENV1” and “ENV2” and a file named “FileA” are required for running the container. The system can then compare the native resources to the configuration requirements and determine that the specification is missing the environment variable “ENV2”. Thus, if the container is executed, the container may encounter an error related to the missing environment variable. As a result, the system can prevent the container from running. In addition, the system can generate a notification indicating the missing environment variable that can be output at a user interface of a computing device.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

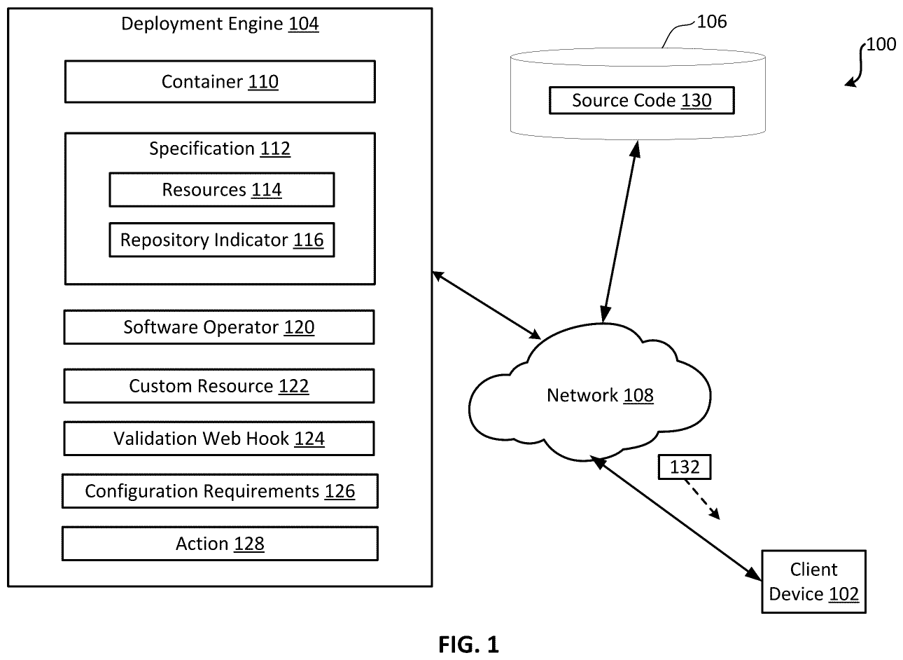

FIG. 1 is a block diagram of an example of a system 100 for configuration validation for container deployments in a computing environment according to some aspects. The system 100 includes one or more client devices 102 communicatively coupled to a deployment engine 104 and a repository 106 via a network 108, such as a local area network (LAN), wide area network (WAN), the Internet, or any combination of these. The client devices 102 can include computing devices (e.g., desktop computers, laptop computers, mobile devices, or servers) on which one or more developers can edit working copies of source code 130 for software for a container 110 and periodically submit the working copies to the repository 106 as commits. A “commit” is source code submitted by a developer to a continuous integration tool for merging into the shared mainline code-base.

The deployment engine 104 may be a computing device such as a server or desktop computer that is executing Kubernetes, Docker, or any other container orchestration platform. The deployment engine 104 can include a software operator 120 that monitors deployment specifications for containers. The software operator 120 can automate various repeatable tasks, such as deployment, scaling, and backup of software resources. In the context of Kubernetes, the software operator 120 can be a software extension that can manage an assigned software resource, such as the container 110. Once deployed, software operator 120 can create, configure, and manage instances of its assigned software resources on behalf of a user in a declarative way.

In some examples, the deployment specifications are specifications indicating resources (e.g., Kubernetes native resources) involved in running containers. The deployment specifications indicate the resources defined and available for the deployment. The resources may include Yet Another Markup Language (YAML) referencing an image for a container, config maps storing configuration data for the deployment, secrets that authenticate users and authorize access to a container, environment variables used by processes in a container, etc. As illustrated in FIG. 1, the container 110 may have a specification 112 that indicates the resources 114 involved in running the container 110. The software operator 120 may discover the specification 112 in response to a request for a deployment of the container 110. That is, the deployment engine 104 may receive the specification 112 as the request for a deployment of the container 110.

In some instances, the software operator 120 may monitor for specifications that include indicators for repositories that store source code associated with the containers. For instance, the software operator 120 may determine that the specification 112 for the container 110 includes the repository indicator 116 that identifies the repository 106 as storing the source code 130 for the container 110. The repository indicator 116 may be added by a developer during creation of the container 110.

In some examples, in response to determining that the container 110 is associated with the repository indicator 116 and prior to running the container 110, the software operator 120 can access the repository 106 to determine configuration requirements 126 for running the container 110 based on the source code 130 for the container 110. For instance, the software operator 120 may perform static analysis on the repository 106 to determine the configuration requirements 126. The static analysis may involve parsing configuration files, identifying environment variable usages, or looking for specific code patterns that indicate required configurations. As such, the configuration requirements 126 can include secrets, environment variables, volume mounts, and the like. Environment variables may include database connection details, application programming interface (API) keys, authentication credentials, or other settings specific to the container 11. In addition, the configuration requirements 126 may indicate specific files that to be present at runtime of the container 110, such as configuration files, secure sockets layer (SSL) certificates, or data files. The static analysis can be language specific and may use sub-operators for each language.

In addition, the software operator 120 may determine one or more resources that are optional for running the container 110 based on the repository 106. For instance, the software operator 120 may determine files or other configuration elements that are configurable subsequent to a startup of the container 110. These resources may be included in the configuration requirements 126 with an indication (e.g., tag) that they can be dynamically set after startup and are thus not mandatory to be present at startup of the container 110.

In some examples, the software operator 120 may also generate a custom resource 122 associated with the deployment of the container 110. The custom resource 122 can indicate the configuration requirements 126 determined from the static analysis. For instance, the custom resource 122 may indicate that environment variables named “ENV1” and “ENV2” are required for running the container 110. The resources that are configurable after the startup of the container 110 can also be indicated in the custom resource 122 as exceptions. The exceptions may also be added manually by a developer. In addition, the software operator 120 can also create a validation web hook 124 for the deployment to prevent the container 110 from running until its configuration is validated.

The software operator 120 can then determine whether the resources 114 involved in running the container 110 satisfy the configuration requirements 126. So, the software operator 120 can compare the resources 114 to the configuration requirements 126 to determine whether any of the configuration requirements 126 are missing from the resources 114. If a resource is missing, the software operator 120 can determine that there is a mismatch between the resources 114 and the configuration requirements 126. Otherwise, if no resource is missing compared to the configuration requirements 126, the software operator 120 can determine that there is a match between the resources 114 and the configuration requirements 126. In an example, if the configuration requirements 126 indicate that environment variables named “ENV1” and “ENV2” are required for running the container 110, but the resources 114 only include ENV1 and lack ENV2, then the software operator 120 can determine that there is a mismatch between the resources 114 and the configuration requirements 126 since ENV2 is missing from the resources 114.

In some examples, the software operator 120 can perform an action 128 based on the match or the mismatch. In the case of a match, the software operator 120 may cause the deployment of the container 110 since the resources 114 include all of the configuration requirements 126. In addition, if there is a mismatch, but the resource that is missing compared to the configuration requirements 126 is configurable after the startup of the container 110, the software operator 120 may also cause the container 110 to be deployed since the resource is not necessary for the startup.

In some instances, if there is a mismatch, the software operator 120 can prevent an execution of the container 110. This may be done by returning an error for the validation web hook 124. In this way, runtime errors may be reduced since the container 110 may be prevented from executing until the resources 114 match the configuration requirements 126. Additionally or alternatively, the action 128 may involve causing a notification 132 indicating the mismatch to be presented at a user interface of one or more of the client devices 102. The client devices 102 may be associated with relevant stakeholders such as developers or operators. The notification 132 may provide an informative error message or event that indicates a configuration requirement that is missing from the resources 114. For instance, the software operator 120 may update the custom resource 122 to indicate the missing configuration requirement of the configuration requirements 126. The updated custom resource can then be displayed as or along with the notification 132 at the user interface. As an example, the custom resource 122 may be updated to indicate that the configuration requirements 126 are not met by the resources 114. In addition, the custom resource 122 can be updated to indicate which of the configuration requirements 126 is missing.

The software operator 120 can continuously monitor the deployment of the container 110 while the repository indicator 116 and the custom resource 122 exist. In this way, the software operator 120 can initially determine that there is a mismatch between the resources 114 and the configuration requirements 126 and prevent the container 110 from being deployed. Then subsequently, the software operator 120 can determine there is an update to the repository 106 that includes the missing resource so that the resources 114 and the configuration requirements 126 now match. At this point, the software operator 120 can cause the container 110 to be deployed.

In another example, the software operator 120 may initially determine that there is a match between the resources 114 and the configuration requirements 126 and cause the container 110 to be deployed. Then subsequently, the software operator 120 can determine there is an update to the repository 106 that removes a resource included in the configuration requirements 126 from the resources 114 so that there is now a mismatch. At this point, the software operator 120 can cause the container 110 to stop executing to reduce a likelihood of the container 110 encountering a runtime error.

While FIG. 1 depicts a specific arrangement of components, other examples can include more components, fewer components, different components, or a different arrangement of the components shown in FIG. 1. For instance, in other examples, the repository storing the source code 130 may be internal to the deployment engine 104. Additionally, the client device 102 can be used to implement the process(es) described herein.

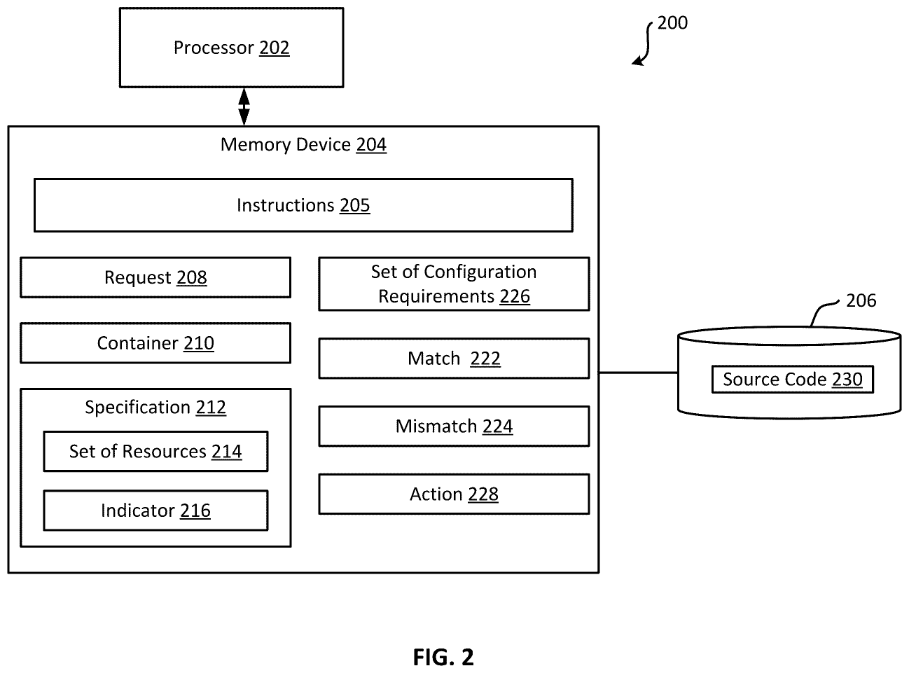

FIG. 2 is a block diagram of another example of a system for configuration validation for container deployments in a computing environment according to some aspects of the present disclosure. The system 200 can include a processor 202 communicatively coupled to a memory device 204. In some examples, the processor 202 may execute a software operator, such as software operator 120 in FIG. 1, to validate container configurations.

The processor 202 can include one processing device or multiple processing devices. The processor 202 can be referred to as a processor. Non-limiting examples of the processor 202 include a Field-Programmable Gate Array (FPGA), an application-specific integrated circuit (ASIC), and a microprocessor. The processor 202 can execute instructions 205 stored in the memory device 204 to perform operations. In some examples, the instructions 205 can include processor-specific instructions generated by a compiler or an interpreter from code written in any suitable computer-programming language, such as C, C++, C#, Java, Python, or any combination of these.

The memory device 204 can include one memory device or multiple memory devices. The memory device 204 can be non-volatile and may include any type of memory device that retains stored information when powered off. Non-limiting examples of the memory device 204 include electrically erasable and programmable read-only memory (EEPROM), flash memory, or any other type of non-volatile memory. At least some of the memory device 204 includes a non-transitory computer-readable medium from which the processor 202 can read instructions 205. A computer-readable medium can include electronic, optical, magnetic, or other storage devices capable of providing the processor 202 with the instructions 205 or other program code executable to perform operations. Non-limiting examples of a computer-readable medium include magnetic disk(s), memory chip(s), ROM, random-access memory (RAM), an ASIC, a configured processor, and optical storage.

In some examples, the processor 202 can execute the instructions 205 to perform operations. The processor 202 can receive a request 208 for a deployment of a container 210. A specification 212 that is associated with the deployment can include a set of resources 214 for running the container 210 and an indicator 216 for a repository 206 storing source code 230 associated with the container 210. Prior to running the container 210, the processor 202 can access the repository 206 to determine a set of configuration requirements 226 for running the container 210. The processor 202 can then determine a match 222 or a mismatch 224 between the set of resources 214 and the set of configuration requirements 226. The mismatch 224 can indicate that one or more of the configuration requirements are missing from the set of resources 214. The processor 202 can perform an action 228 based on the match 222 or the mismatch 224. For instance, if the processor 202 determines the match 222, then the processor 202 may cause an execution of the container 210. But, if the processor 202 determines the mismatch 224, the processor 202 may generate a notification about the mismatch 224 or prevent the container 210 from running until the set of resources 214 matches the set of configuration requirements 226. Thus, by using the source code 230, the processor 202 can preemptively validate the configuration of the container 210 prior to running the container 210. Thus, runtime errors may be reduced for the container 210, resulting in improved performance for the container 210.

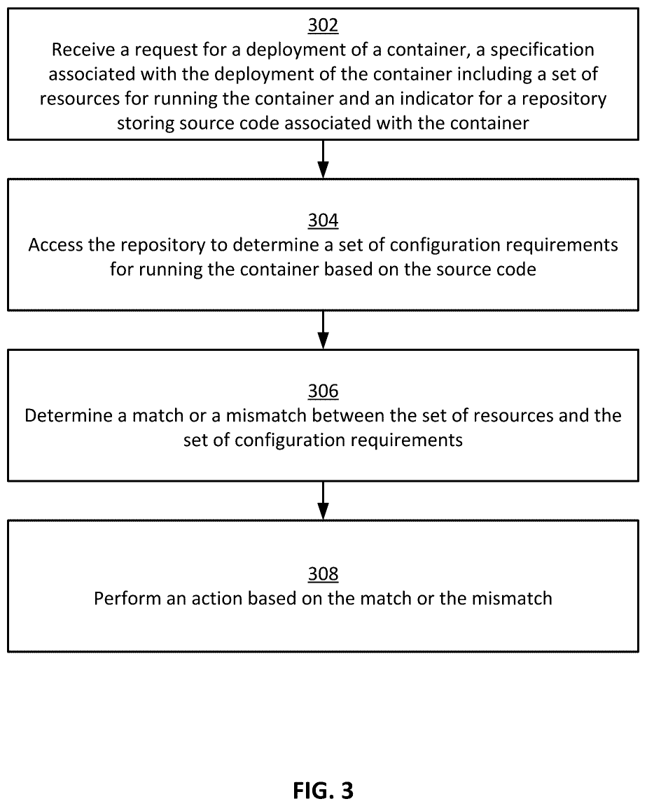

FIG. 3 is a flow chart of an example of a process for configuration validation for container deployments in a computing environment according to some aspects of the present disclosure. In some examples, the processor 202 can perform one or more of the steps shown in FIG. 2. For example, the processor 202 can execute the software operator 120 of FIG. 1 to perform one or more of the steps shown in FIG. 3. In other examples, the processor 202 can implement more steps, fewer steps, different steps, or a different order of the steps depicted in FIG. 3. The steps of FIG. 3 are described below with reference to components discussed above in FIGS. 1-2.

At block 302, the processor 202 can receive a request 208 for a deployment of a container 210. A specification 212 that is associated with the deployment can include a set of resources 214 for running the container 210 and an indicator 216 for a repository 206 storing source code 230 associated with the container 210. For instance, the set of resources 214 may indicate that two files and one environment variable are define for the container 210. The repository 206 may be a Git repository. The processor 202 can generate a custom resource 122 for the deployment of the container 210 and a validation web hook 124 for the deployment of the container 210.

At block 304, prior to running the container 210, the processor 202 can access the repository 206 to determine a set of configuration requirements 226 for running the container 210. The processor can may perform static analysis on the repository 206 to determine the configuration requirements 226, which may include secrets, environment variables, volume mounts, files, and the like. As an example, the processor 202 may determine that the configuration requirements 226 include two files and two environment variables. In addition, the processor 202 may determine one or more resources that are optional for running the container 210 based on the repository 206.

At block 306, the processor 202 can determine a match 222 or a mismatch 224 between the set of resources 214 and the set of configuration requirements 226. By comparing the set of resources 214 to the set of configuration requirements 226, the processor 202 can determine if any resources included in the set of configuration requirements 226 are missing from the set of resources 214, which corresponds to the mismatch 224. In addition, the processor 202 can determine whether all of the resources included in the set of configuration requirements 226 are included in the set of resources 214, which corresponds to the match 222. For example, the processor 202 may determine that, since the set of resources 214 includes two files and one environment variable and the set of configuration requirements 226 includes two files and one environment variable, there is the mismatch 224 between the set of resources 214 and the set of configuration requirements 226.

At block 308, the processor 202 can perform an action 228 based on the match 222 or the mismatch 224. In response to determining the match 222, the processor 202 may cause the deployment of the container 210. In response to determining the mismatch 224, the processor 202 may prevent an execution of the container 210. Additionally or alternatively, the action 228 may involve causing a notification 132 indicating the mismatch 224 to be presented at a user interface of one or more of client devices 102. The notification 132 may indicate a configuration requirement of the set of configuration requirements 226 that is missing from the set of resources 214. In addition, the processor 202 may update the custom resource 122 to indicate the missing configuration requirement of the set of configuration requirements 226.

In some examples, the processor 202 can continuously monitor the deployment of the container 210. So, if a resource is added or removed from the set of resources 214 or the set of configuration requirements 226, the processor 202 can reevaluate for a match or a mismatch between the set of resources 214 and the set of configuration requirements 226 to determine another action to perform for the container 210. For instance, the processor 202 may determine whether to start or stop the container 210. So, in general, by having specifications that indicate repositories that store source code for containers, the configuration requirements are determinable before executions of the containers. Thus, the resources defined for a deployment can be validated as being sufficient or not for running the container prior to the container being executed, leading to reduced runtime errors and improved performance for deployments.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

1. A system comprising:
a processor; and
a memory device storing program code that is executable by the processor for causing the processor to perform operations including:
receiving a request for a deployment of a container, a specification associated with the deployment of the container including a set of resources for running the container and an indicator for a repository storing source code associated with the container;
prior to running the container:
accessing the repository to determine a set of configuration requirements for running the container based on the source code;
determining a match or a mismatch between the set of resources and the set of configuration requirements; and
performing an action based on the match or the mismatch.

2. The system of claim 1, wherein the operations further comprise:
monitoring a plurality of specifications to determine a subset of the plurality of specifications that include the indicator, the subset of the plurality of specifications including the specification; and
in response to determining the specification includes the indicator, generating a custom resource associated with the deployment of the container, wherein the custom resource indicates the set of configuration requirements.

3. The system of claim 2, wherein performing the action comprises:
updating the custom resource to indicate a missing configuration requirement of the set of configuration requirements based on determining the mismatch.

4. The system of claim 1, wherein performing the action comprises:
preventing an execution of the container based on determining the mismatch.

5. The system of claim 1, wherein performing the action comprises:
causing a notification indicating the mismatch to be presented at a user interface of a client device.

6. The system of claim 1, wherein performing the action comprises:
causing the deployment of the container based on determining the match.

7. The system of claim 1, wherein the set of configuration requirements includes a resource that is configurable subsequent to a startup of the container, and wherein the operations further comprise:
determining the mismatch between the set of configuration requirements and the set of resources based on the resource being missing from the set of resources; and
causing the deployment of the container in response to the mismatch.

8. A computer-implemented method comprising:
receiving a request for a deployment of a container, a specification associated with the deployment of the container including a set of resources for running the container and an indicator for a repository storing source code associated with the container;
prior to running the container:
accessing the repository to determine a set of configuration requirements for running the container based on the source code;
determining a match or a mismatch between the set of resources and the set of configuration requirements; and
performing an action based on the match or the mismatch.

9. The method of claim 8, further comprising:
monitoring a plurality of specifications to determine a subset of the plurality of specifications that include the indicator, the subset of the plurality of specifications including the specification; and
in response to determining the specification includes the indicator, generating a custom resource associated with the deployment of the container, wherein the custom resource indicates the set of configuration requirements.

10. The method of claim 9, wherein performing the action comprises:
updating the custom resource to indicate a missing configuration requirement of the set of configuration requirements based on determining the mismatch.

11. The method of claim 8, wherein performing the action comprises:
preventing an execution of the container based on determining the mismatch.

12. The method of claim 8, wherein performing the action comprises:
causing a notification indicating the mismatch to be presented at a user interface of a client device.

13. The method of claim 8, wherein performing the action comprises:
causing the deployment of the container based on determining the match.

14. The method of claim 8, wherein the set of configuration requirements includes a resource that is configurable subsequent to a startup of the container, and wherein the method further comprises:
determining the mismatch between the set of configuration requirements and the set of resources based on the resource being missing from the set of resources; and
causing the deployment of the container in response to the mismatch.

15. A non-transitory computer-readable medium comprising program code that is executable by a processor for causing the processor to perform operations including:
receiving a request for a deployment of a container, a specification associated with the deployment of the container including a set of resources for running the container and an indicator for a repository storing source code associated with the container;
prior to running the container:
accessing the repository to determine a set of configuration requirements for running the container based on the source code;
determining a match or a mismatch between the set of resources and the set of configuration requirements; and
performing an action based on the match or the mismatch.

16. The non-transitory computer-readable medium of claim 15, wherein the operations further comprise:
monitoring a plurality of specifications to determine a subset of the plurality of specifications that include the indicator, the subset of the plurality of specifications including the specification; and
in response to determining the specification includes the indicator, generating a custom resource associated with the deployment of the container, wherein the custom resource indicates the set of configuration requirements.

17. The non-transitory computer-readable medium of claim 16, wherein performing the action comprises:
updating the custom resource to indicate a missing configuration requirement of the set of configuration requirements based on determining the mismatch.

18. The non-transitory computer-readable medium of claim 15, wherein performing the action comprises:
preventing an execution of the container based on determining the mismatch.

19. The non-transitory computer-readable medium of claim 15, wherein performing the action comprises:
causing a notification indicating the mismatch to be presented at a user interface of a client device.

20. The non-transitory computer-readable medium of claim 15, wherein the set of configuration requirements includes a resource that is configurable subsequent to a startup of the container, and wherein the operations further comprise:
determining the mismatch between the set of configuration requirements and the set of resources based on the resource being missing from the set of resources; and
causing the deployment of the container in response to the mismatch.
